(19) United States
(12) Patent Application Publication
(10) Pub. No.: US 2005/0142409 A1
(43) Pub. Date: Jun. 30, 2005

(54) Fuel cell system and control method thereof

(76) Inventors: Tae-Hee Cho, Changwon (KR); Myung-Seok Park, Gyeongsangnam-Do (KR); Hong Choi, Gyeongsangnam-Do (KR); Kyu-Jung Kim, Seongnam (KR); Myeong-Ho Lee, Busan (KR); Cheol-Hwan Kim, Gimhae (KR); Yong-Jun Hwang, Changwon (KR); Seung-Tae Ko, Daegu (KR); Seong-Geun Heo, Busan (KR)

Correspondence Address: FLESHNER & KIM, LLP, P.O. BOX 221200, CHANTILLY, VA, 20153, US

(21) Appl. No.: 10/483,385

(22) PCT Filed: Dec. 12, 2003
(86) PCT No.: PCT/KR03/02728

(51) Int. Cl. H01M 8/04; H01M 8/10; H01M 8/06

(52) U.S. Cl. 429/26; 429/32; 429/38; 429/22; 429/13; 429/17; 429/19

(57) ABSTRACT

Disclosed is a fuel cell system comprising: a fuel tank connected to a anode of a fuel cell stack for supplying hydrogen-including fuel to the anode; an air supplying unit connected to a cathode of the fuel cell stack for supplying oxygen-including air to the cathode; a heating unit for heating air and fuel supplied to the fuel cell stack; and a purge unit for returning fuel remaining at each system to the fuel tank when a system driving is stopped. According to this, a temperature of the fuel cell stack can reach a goal temperature within the shortest time by heating fuel at the time of driving a system, and fuel remaining at the fuel cell stack and each system is returned to the fuel tank when the system driving is stopped, thereby increasing a performance of the fuel cell system.

### TECHNICAL FIELD

The present invention relates to a fuel cell system, and more particularly, to a fuel cell system capable of increasing a reliability of a fuel cell by making a temperature of a fuel cell stack reach a goal temperature within the shortest time and capable of enhancing a stability of the fuel cell by fast dropping a temperature of the fuel cell stack at the time of stopping the fuel cell, and a control method thereof.

### BACKGROUND ART

In general, a fuel cell system has been proposed as a substitution of fossil fuel and differently from a general cell (a second cell), it supplies fuel (hydrogen or hydrocarbon) to an anode and supplies oxygen to a cathode. Thus, the fuel cell system undergoes an electrochemical reaction between hydrogen and oxygen without a combustion reaction (oxidation reaction) of fuel and thereby directly converts an energy difference between before and after a reaction into electric energy.

As shown in FIG. 1, a fuel cell system in accordance with the conventional art comprises: a fuel cell stack 106 where an anode 102 having an electrolyte membrane (not shown) therein in order to generate electric energy by an electrochemical reaction between hydrogen and oxygen and a cathode 104 are stacked with the plural number; a fuel tank 108 for storing fuel including hydrogen to be supplied to the anode 102; and an air supplying unit 110 for supplying air including oxygen to the cathode 104.

A fuel pump 112 for pumping fuel stored in the fuel tank 108 is installed between the fuel tank 108 and the anode 102 of the fuel cell stack 106.

The air supplying unit 110 includes: an air pump 114 for supplying air in the atmosphere to the cathode 104 of the fuel cell stack 106; an air filter 116 for filtering air supplied to the fuel cell stack 106; and a humidifier 118 for humidifying air supplied to the fuel cell stack 106. Herein, the humidifier 118 is provided with a water tank 120 for supplying water to the humidifier 118.

Processes for generating electric energy by supplying fuel to the conventional fuel cell will be explained as follows.

If the fuel pump 112 is operated by a control signal of a control unit (not shown), fuel stored in the fuel tank 108 is pumped thus to be supplied to the anode 102 of the fuel cell stack 106. Also, if the air pump 114 is operated, air filtered by the air filter 116 passes through the humidifier 118 thus to be humidified and is supplied to the cathode 104 of the fuel cell stack 106.

Once fuel and air are supplied to the fuel cell stack 106, an electrochemical oxidation of hydrogen is performed in the anode 102 and an electrochemical deoxidation of oxygen is performed in the cathode 104 in a state that the electrolyte membrane (not shown) is positioned between the anode 102 and the cathode 104. At this time, generated electron moves and thereby electricity is generated. The generated electricity is supplied to a load 126.

In the conventional fuel cell system, it takes a lot of time to make a temperature of the fuel cell stack reach a goal temperature, so that a reliability and a function of the fuel cell are degraded.

Also, a temperature of the fuel cell stack is maintained to be high even after stopping the fuel cell, so that a stability of the fuel cell is lowered.

### DISCLOSURE OF THE INVENTION

Therefore, it is an object of the present invention to provide a fuel cell system capable of increasing a reliability and a function of a fuel cell by making a temperature of a fuel cell stack reach a goal temperature within the shortest time by heating fuel by using heat generated when fuel powder is mixed with water and heat generated when hydrogen generated from an anode of the fuel cell stack is ignited, and a control method thereof.

It is another object of the present invention to provide a fuel cell system capable of increasing a stability of a fuel cell by fast dropping a temperature of a fuel cell stack when the fuel cell system is stopped and capable of increasing a performance by returning fuel remaining at each system to a fuel tank, and a control method thereof.

To achieve these objects, there is provided a fuel cell system comprising: a fuel cell stack that an anode and a cathode are arranged in a state that an electrolyte membrane is interposed therebetween; a fuel tank connected to the anode of the fuel cell stack by a fuel supplying line for supplying hydrogen-including fuel to the anode; an air supplying unit connected to the cathode of the fuel cell stack by an air supplying line for supplying oxygen-including air to the cathode; a heating unit for heating air and fuel supplied to the fuel cell stack; and a purge unit for returning fuel remaining at each system to the fuel tank when a system driving is stopped.

A cooling fan for cooling the fuel cell stack when the system driving is stopped is installed at the fuel cell stack.

The heating unit is composed of a hydrogen combustor installed at the fuel supplying line and the air supplying line for heating fuel and air supplied to the fuel cell stack by using hydrogen generated from the fuel cell stack as a heating source.

The purge unit is composed of a fuel recollecting line connected between the fuel cell stack and the fuel tank for recollecting fuel discharged from the fuel cell stack into the fuel tank, and a recycling pump installed at the fuel recollecting line for returning fuel remaining at each system to the fuel tank through the fuel recollecting line when a system driving is stopped.

To achieve these objects, there is also provided a method for controlling a fuel cell system comprising: a heating step for heating fuel; an electricity generating step for supplying the heated fuel and air to a fuel cell stack and thus generating electric energy; and a purge step for returning fuel remaining at each system to a fuel tank when a system driving is stopped while performing the first and second steps.

The heating step further comprises a step for driving a system by using a power source of a battery after heating fuel.

In the heating step, fuel is heated by using heat generated when fuel is mixed with water.

In the heating step, a fuel kit where fuel powder (NaOH and BH₄ powder) is stored is mounted to a fuel tank where water is stored and thereby fuel powder is mixed with water.

In the purge step, a recycle pump is driven to recollect fuel remaining at the fuel cell stack and each line to the fuel tank through a recollecting line when a system driving is stopped.

### BRIEF DESCRIPTION OF THE DRAWINGS

FIG. 1 is a construction view of a fuel cell system in accordance with the conventional art;

FIG. 2 is a construction view of a fuel cell system according to one embodiment of the present invention;

FIG. 3 is a sectional view of a fuel tank of a fuel cell system according to the present invention;

FIG. 4 is a block diagram showing a control means of a fuel cell system according to one embodiment of the present invention;

FIG. 5 is a construction view of a fuel cell system according to another embodiment of the present invention; and

FIG. 6 is a flow chart showing a control method of a fuel cell system according to one embodiment of the present invention.

### MODES FOR CARRYING OUT THE PREFERRED EMBODIMENTS

Hereinafter, a control method of a fuel cell system according to the present invention will be explained with reference to attached drawings.

Even if a plurality of embodiments can exist in the control method of a fuel cell system according to the present invention, the most preferable embodiment will be explained.

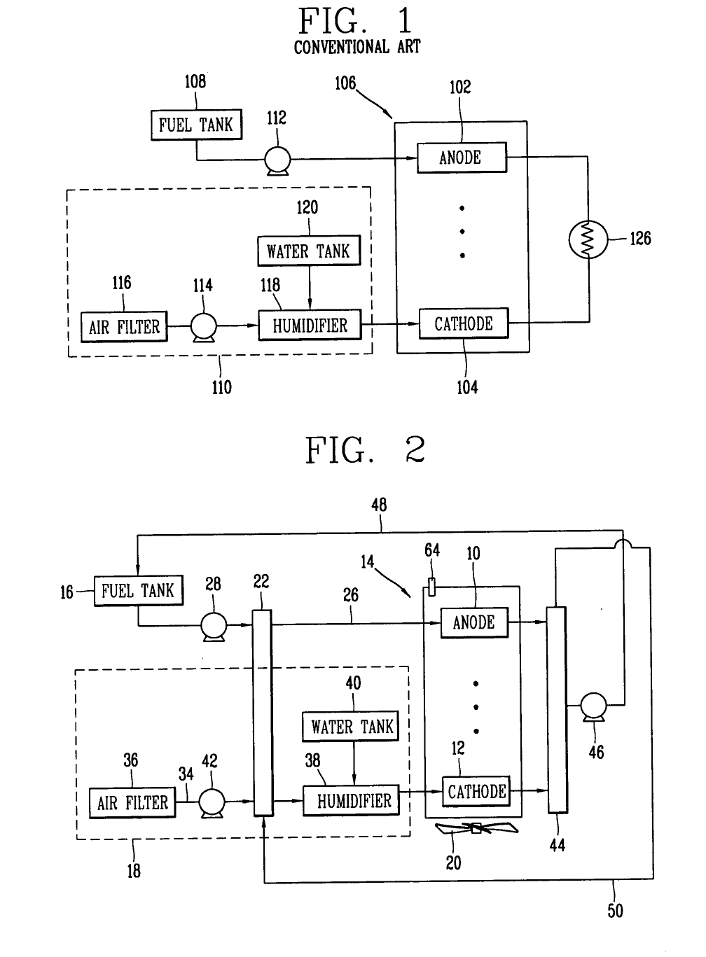

FIG. 2 is a construction view of a fuel cell system according to one embodiment of the present invention.

A fuel cell system according to the present invention comprises: a fuel cell stack 14 where an anode 10 having an electrolyte membrane (not shown) therein in order to generate electric energy by an electrochemical reaction between hydrogen and oxygen and a cathode 12 are stacked with the plural number; a fuel tank 16 for storing fuel to be supplied to the anode 10; an air supplying unit 18 for supplying oxygen including air to the cathode 12; a hydrogen combustor 22 for heating fuel and air supplied to the fuel cell stack 14 by using hydrogen generated from the anode 10 after a reaction; a purge unit for recollecting fuel remaining at each system to the fuel tank 16 when the system is stopped; and a control means for controlling each component.

The fuel cell stack 14 is provided with a cooling fan 20 for cooling the fuel cell stack 14.

The fuel tank 16 is connected to the anode 10 of the fuel cell stack 14 by a fuel supplying line 26, and a fuel pump 28 for pumping fuel stored in the fuel tank 16 is installed at one side of the fuel supplying line 26.

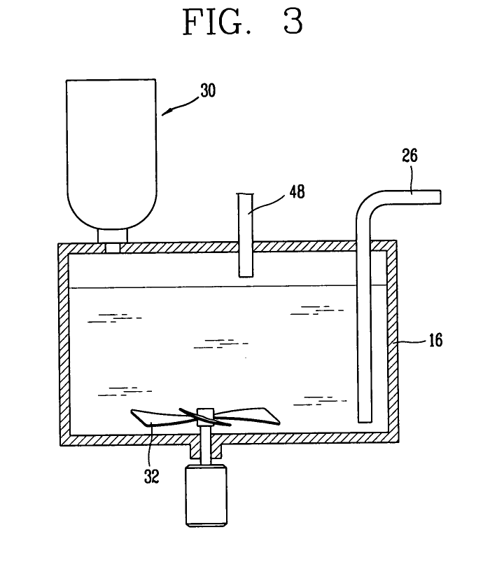

Also, as shown in FIG. 3, the fuel tank 16 includes a fuel kit 30 for increasing a temperature of fuel by using reaction heat generated when fuel powder is mixed with water stored in the fuel tank 16 before operating the fuel cell system; and a blade 32 for making fuel power be mixed with water well when the fuel power is supplied to the fuel tank 16 from the fuel kit 30.

The fuel power stored in the fuel kit 30 is composed of NaOH and BH₄. If the NaOH is mixed with water, a reaction is performed as a following reaction formula and heat is generated.
NaOH+H₂O->NaOH (H₂O)+9˜13 Kcal/mol Reaction formula:

The air supplying unit 18 includes: an air supplying line 34 for introducing air in the atmosphere to the cathode 12 of the fuel cell stack 14; an air filter 36 installed at an entrance of the air supplying line and filtering air sucked into the air supplying line 34; an air pump 42 installed at one side of the air supplying line 34 and generating a suction power for sucking external air; and a humidifier 38 for humidifying air sucked by the air pump 42. The humidifier 38 is provided with a water tank 40 for supplying water.

The purge unit can be implemented by various methods, which will be explained as follows.

The purge unit according to one embodiment includes: a gas/liquid separator 44 for separating fuel discharged from the anode 10 of the fuel cell stack 14 after reaction into gas and liquid; a recycling line 48 for recollecting liquid fuel discharged from the gas/liquid separator 44 into the fuel tank 16;
and a recycling pump 46 installed at the recycling line 48 and pumping recycling liquid fuel to the fuel tank 16.

The purge unit according to one embodiment recollects fuel remaining at the fuel cell stack 14 to the fuel tank 16 through the recycling line 48 by driving the recycling pump 46 for a certain time after the system is stopped.

NaBO₂ and 4H₂ generated in the anode 10 of the fuel cell stack 14 after reaction are separated into gas and liquid. Herein, water and NaBO₂ of liquid are recollected into the fuel tank 16 through the fuel recycling line 48 and the hydrogen gas is exhausted outside.

The hydrogen combustor 22 is connected with the fuel supplying line 26 and the air supplying line 34 and connected with the gas/liquid separator by a hydrogen supplying line 50, thereby heating fuel and air which pass through the fuel supplying line 26 and the air supplying line 34 by using heat generated when hydrogen supplied from the gas/liquid separator 44 is ignited.

The purge unit according to a second embodiment reversely drives the fuel pump 28 when the system is stopped and thereby returns fuel remaining at the fuel cell stack 14 and each line to the fuel tank 16. That is, when the system is stopped, the purge unit drives the fuel pump 28 in a reverse direction by a control unit 80 for a certain time.

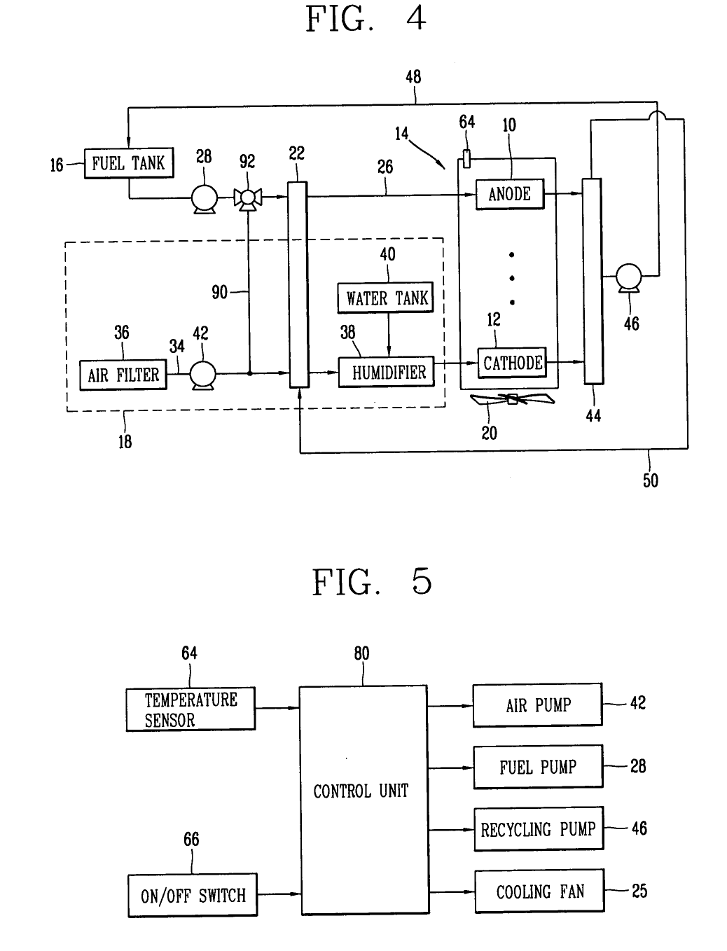

The purge unit according to a third embodiment, as shown in FIG. 4, is composed of a purge line connected between the fuel supplying line and the air supplying line, and a three-way valve installed at a part where the purge line and the fuel supplying line are connected to each other.

In the purge unit according to the third embodiment, the three-way valve is operated to connect the air supplying line and the anode each other when the system is stopped, and the air pump 42 is operated to supply air to the anode and thereby fuel remaining at the anode is returned to the fuel tank through the recycling line.

FIG. 5 is a block diagram showing a control means for controlling the fuel cell system according to the present invention.

The control means includes: a temperature sensor 64 installed at the fuel cell stack 14 and detecting a temperature of the fuel cell stack 14; an on/off switch 66 for turning on/off a fuel cell; and a control unit 80 for controlling an operation of each component according to signals applied from the temperature sensor 64 and the on/off switch 66.

A control method of the fuel cell system according to the present invention will be explained as follows.

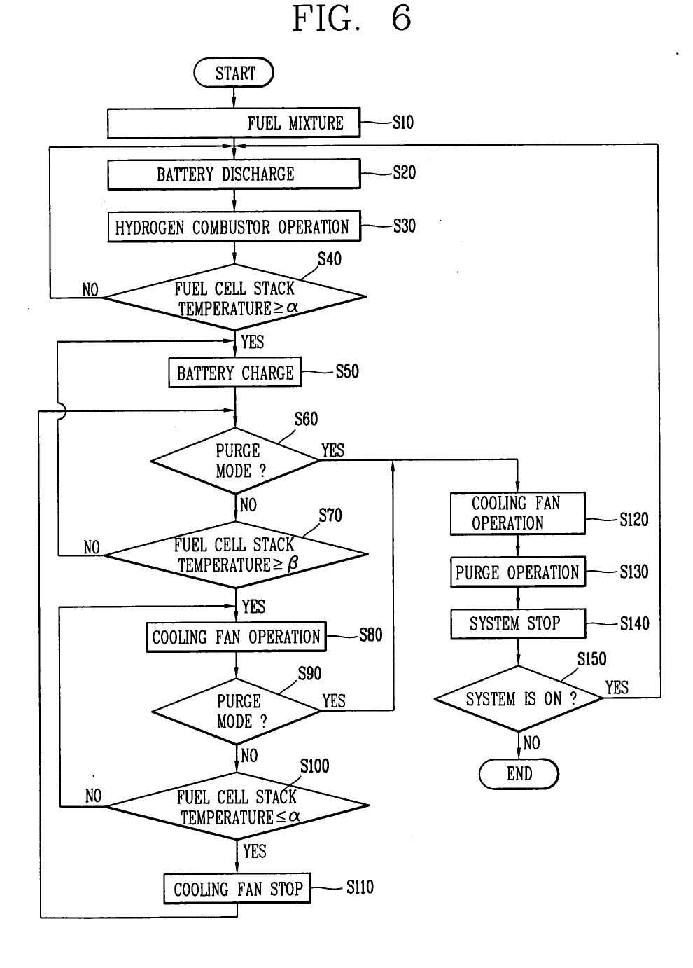

FIG. 6 is a flow chart showing a control method of the fuel cell system according to the present invention.

First, the fuel kit 30 is mounted at the fuel tank 16 thus to mix water stored in the fuel tank 16 with fuel powder stored in the fuel kit 30, thereby fabricating fuel solution. At this time, as said water and fuel powder are mixed with each other in the fuel tank 16, heat is generated (S10).

Also, if a temperature of the fuel solution reaches a proper level, the fuel cell system is operated by a power of a battery (not shown) (S20).

That is, by a power of the battery, the fuel pump 28 is operated and thereby fuel of which temperature is increased by a mixture in the fuel tank 16 is supplied to the anode 10 of the fuel cell stack 14. At the same time, by a power of the battery, the air pump 42 is operated and thereby air is supplied to the cathode 12 from the air supplying unit 18. According to this, fuel and air react with the electrolyte membrane thus to form ions. In the process that the ions form water by an electrochemical reaction, electron is generated from the anode 10 and moves to the cathode 12, thereby generating electricity.

Also, hydrogen generated from the anode 10 of the fuel cell stack 14 after reaction is obtained by the gas/liquid separator 44 thus to be supplied to the hydrogen supplying line 50.

The hydrogen exhausted from the gas/liquid separator 44 is supplied to the hydrogen combustor 22 through the hydrogen supplying line 50. Then, the hydrogen is ignited in the hydrogen combustor 22 thus to generate heat, and fuel and air supplied to the fuel cell stack 14 are heated by passing through the hydrogen combustor 22 (S30).

Like this, at the first stage, fuel is heated by using heat generated from a mixture between fuel and water in the fuel tank 16, and after the fuel cell system is operated, fuel is heated by the hydrogen combustor 22. According to this, a temperature of the fuel cell stack 14 can reach a goal temperature within the shortest time.

While the fuel cell system is operated, it is judged that a temperature of the fuel cell stack 14 is higher than a set temperature a or not (S40).

That is, if the temperature sensor 64 mounted at the fuel cell stack 14 detects a temperature of the fuel cell stack 14 and thus applies to the control unit 80, the control unit 80 compares a temperature of the fuel cell stack 14 with the set temperature a and thereby judges that a temperature of the fuel cell stack 14 is more than the set temperature a. Herein, the set temperature a is preferably set as 60° C.

In said process, if a temperature of the fuel cell stack 14 is judged to be more than the set temperature α, the battery is charged, the system is operated by using electric current generated from the fuel cell stack 14, and current is supplied to a load (S50).

While the fuel cell system is operated, it is judged that the system is a purge mode state (S60). That is, it is judged that the user stops the system by adjusting the on/off switch 66 in order to stop the fuel cell system or not.

Herein, if it is judged that the system is not the purge mode state, it is judged that a temperature of the fuel cell stack 14 is higher than a set temperature β (S70). That is, if the temperature sensor 64 detects a temperature of the fuel cell stack 14 and thereby applies to the control unit 80, the control unit 80 compares a temperature of the fuel cell stack 14 with the set temperature β. Herein, the set temperature β is preferably set as approximately 80° C.

In said process, if a temperature of the fuel cell stack 14 is judged to be higher than the set temperature, the cooling fan 20 is operated thus to prevent a temperature of the fuel cell stack 14 from being increased more than the set temperature β.

Again, it is judged that the system is a purge mode state (S90).

If the system is not a purge mode state, it is judged that a temperature of the fuel cell stack 14 becomes lower than the set temperature a (S100).

Also, if it is judged that a temperature of the fuel cell stack 14 becomes lower than the set temperature α, the control unit 80 stops an operation of the cooling fan 20 (S110).

In the steps of S60 and S90, if it is judged that the system is a purge mode state, that is, if the user adjusts the on/off switch 66 into off, the control unit 80 operates the cooling fan 20 by electric signals applied from the on/off switch 66 thus to perform a cooling of the fuel cell stack 14 and to perform a purge operation of the system (S120 and S130).

Herein, the purge operation is an operation for recollecting fuel remaining at each line of the system or the fuel cell stack 14 into the fuel tank 16 before stopping the system.

Various embodiments of the purge operation will be explained as follows.

By the purge operation according to one embodiment, the control unit 80 drives the recycling pump 46 for a certain time when the system is stopped and thereby recollects fuel remaining at the fuel cell stack 14 and each line to the fuel tank 16 through the recycling line 48.

By the purge operation according to the second embodiment, the control unit 80 reversely drives the fuel pump 28 when the system is stopped, and thereby returns fuel remaining at the fuel supplying line 26 and the fuel cell stack 14 to the fuel tank 16.

By the purge operation according to the third embodiment, the control unit 80 operates the three-valve thus to connect the air supplying line and the anode of the fuel cell stack each other and the air pump is driven thus to inject air into the anode, thereby returning fuel remaining at the anode to the fuel tank 16 through the recycling line 48.

Then, if the purge operation is completed, the system is stopped (S140).

The purge mode can be applied to any step since the user can stop the fuel cell system if necessary while the system is operated. Also, if the on/off switch 66 is adjusted into on in order to re-operate the system by the user after the system is stopped, a power of the battery is transmitted to each part of the system thus to repeat said processes (S150).

According to the fuel cell system and the control method thereof, at the first stage, fuel is heated by using heat generated when fuel power is mixed with water, and after the system is operated, fuel is heated by using hydrogen generated at the anode after reaction. Therefore, a temperature of the fuel cell stack can reach a goal temperature within the shortest time thus to enhance a function and a reliability of the fuel cell.

Also, when the fuel cell system is temporarily stopped or an operation of the fuel cell system is finished, the cooling fan is operated thus to cool the fuel cell system within a short time, thereby enhancing a stability of the system.

Besides, when the system is stopped, fuel remaining at the fuel cell stack and each system is returned to the fuel tank thus to increase a performance.

It will be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

1. A fuel cell system comprising:
a fuel cell stack that an anode and a cathode are arranged in a state that an electrolyte membrane is interposed therebetween;
a fuel tank connected to the anode of the fuel cell stack by a fuel supplying line for supplying hydrogen-including fuel to the anode;
an air supplying unit connected to the cathode of the fuel cell stack by an air supplying line for supplying oxygen-including air to the cathode;
a heating unit for heating air and fuel supplied to the fuel cell stack; and
a purge unit for returning fuel remaining at each system to the fuel tank when a system driving is stopped.

2. The fuel cell system of claim 1, wherein a cooling fan for cooling the fuel cell stack when the system driving is stopped is installed at the fuel cell stack.

3. The fuel cell system of claim 1, wherein the heating unit is composed of a hydrogen combustor installed at the fuel supplying line and the air supplying line for heating fuel and air supplied to the fuel cell stack by using hydrogen generated from the fuel cell stack as a heating source.

4. The fuel cell system of claim 1, wherein the heating unit is composed of a fuel kit installed at the fuel tank for heating fuel by using heat generated when fuel power is mixed with water stored in the fuel tank.

5. The fuel cell system of claim 1, wherein the purge unit is composed of:
a fuel recollecting line connected between the fuel cell stack and the fuel tank for recollecting fuel discharged from the fuel cell stack into the fuel tank; and
a recycling pump installed at the fuel recollecting line for returning fuel remaining at each system to the fuel tank through the fuel recollecting line when a system driving is stopped.

6. The fuel cell system of claim 1, wherein the purge unit is composed of:
a fuel pump installed at the fuel supplying line for pumping fuel; and
a controller for returning fuel remaining at each system to the fuel tank by reversely driving the fuel pump when a system driving is stopped.

7. The fuel cell system of claim 1, wherein the purge unit is composed of a purge line connected between the fuel supplying line and the air supplying line and a three-way valve installed at a part where the purge line and the fuel supplying line are connected to each other, and returns remaining fuel to the fuel tank by injecting air into the anode when a system driving is stopped.

8. A method for controlling a fuel cell system comprising:
a heating step for heating fuel;
an electricity generating step for supplying the heated fuel and air to a fuel cell stack and thus generating electric energy; and
a purge step for returning fuel remaining at each system to a fuel tank when a system driving is stopped while performing the first and second steps.

9. The method of claim 8, further comprising a step for driving a system by using a power source of a battery after heating fuel in the heating step.

10. The method of claim 8, wherein fuel is heated by using heat generated when fuel is mixed with water in the heating step.

11. The method of claim 10, wherein a fuel kit where fuel powder (NaOH and BH₄ powder) is stored is mounted to a fuel tank where water is stored and thereby fuel powder is mixed with water in the heating step.

12. The method of claim 8, wherein fuel is heated by using hydrogen generated from the anode of the fuel cell stack as a heating source in the heating step.

13. The method of claim 8, further comprising a step for charging a battery when a temperature of the fuel cell stack is higher than a set temperature in the electricity generating step.

14. The method of claim 8, wherein a recycle pump is driven to recollect fuel remaining at the fuel cell stack and each line to the fuel tank through a recollecting line when a system driving is stopped in the purge step.

15. The method of claim 14, further comprising a step for cooling the fuel cell stack by driving a cooling fan in the purge step.

16. The method of claim 8, wherein fuel remaining at the fuel supplying line and the fuel cell stack is returned to the fuel tank by reversely driving a fuel pump in the purge step.

17. The method of claim 8, wherein fuel remaining at the fuel cell stack is returned to the fuel tank by injecting air into the anode of the fuel cell stack when a system driving is stopped in the purge step.
